(19) United States
(12) Patent Application Publication
(10) Pub. No.: US 2018/0145875 A1
(43) Pub. Date: May 24, 2018

(54) INFORMATION PROCESSING DEVICE

(71) Applicant: FUJITSU LIMITED, Kawasaki-shi (JP)

(72) Inventor: Nobuyuki SHICHINO, Kahoku (JP)

(73) Assignee: FUJITSU LIMITED, Kawasaki-shi, Kanagawa (JP)

(21) Appl. No.: 15/795,415

(22) Filed: Oct. 27, 2017

(30) Foreign Application Priority Data
Nov. 24, 2016 (JP) 2016-227873

(51) Int. Cl. H04L 12/24; H04L 29/12

(52) U.S. Cl. CPC H04L 41/0803; H04L 69/16; H04L 61/25

(57) ABSTRACT

An information processing device includes a plurality of processing modules. One of the plurality of processing modules includes a storage unit storing configuration information for defining the configuration of the information processing device. When a request related to the configuration information in the storage unit is received from an external terminal, the one processing module performs the request. When the requests are received from one request source in the external terminal, each processing module performs conversion to replace a transmission source address and a port number of each request with the same internal address and internal port number. The information processing device determines whether or not to permit performing each request on the basis of the internal address and the internal port number replaced by the conversion. In this way, it is possible to simply perform exclusive control for a request for the configuration information of a redundant system.

### CROSS-REFERENCE TO RELATED APPLICATION

This application is based upon and claims the benefit of priority of the prior Japanese Application No. 2016-227873 filed on Nov. 24, 2016 in Japan, the entire contents of which are hereby incorporated by reference.

### FIELD

The present invention relates to an information processing device.

### BACKGROUND

In some cases, an information processing device, such as a storage device or a server device, is configured as a redundant system having a redundant structure formed by a plurality of devices (for example, processing units or processing modules). In the redundant system, one of a plurality of devices functions as a master and one or more devices other than the master among the plurality of devices function as slaves. It is possible to dynamically change whether each device functions as the master or the slave during operation.

Each device (master/slave) includes an external network interface for transmission control protocol (TCP) communication with an external client (terminal). An external network is connected to the external network interface and each device is connected to a client through the external network interface and the external network so as to perform TCP communication with the client.

There are a plurality of clients connected to the above-mentioned redundant system. Each client is arbitrarily connected to any one of a plurality of devices (master/slave). Each client logs in the device (the master or the slave) connected through the external network interface and is capable of referring to/changing system configuration information for defining, for example, the configuration of the redundant system. In the redundant system, the system configuration information is managed in an integrated fashion by the master. Hereinafter, in some cases, the system configuration information is simply referred to as configuration information.

In this case, preferably, a user issues requests to refer to/change the system configuration information, using the client, without being aware of whether the connected device is the master or the slave. In other words, it is preferable to perform an operation of referring to/changing the system configuration information, regardless of whether the client is connected to the master or the slave.

Therefore, preferably, a lock mechanism is introduced for the management of the system configuration information to perform exclusive control such that two or more devices do not perform, for example, the process of referring to/changing the system configuration information at the same time.
Patent Document 1: JP 2003-196140 A
Patent Document 2: JP 2006-94106 A
Patent Document 3: JP 2015-70522 A

However, since the exclusive control is complicated, the cost of achieving the exclusive control is high. For example, in the exclusive control, the master or the slave performs communication between the master and the slave to acquire a right to issue, for example, a reference/change request. In this communication, a band provided for an input/output service for the client which originally has priority is pressed, which results in an increase in costs.

### SUMMARY

An information processing device according to an aspect of the invention includes a plurality of processing modules. Among the plurality of processing modules, one processing module includes a first storage unit that stores configuration information for defining a configuration of the information processing device. When one or more requests related to the configuration information in the first storage unit are received from an external terminal, the one processing module performs each of the requests. When the requests are received from one request source of a plurality of requests sources in the external terminal, each of the plurality of processing modules performs conversion to replace an address and a port number of each of the requests with a same internal address and a same internal port number. The information processing device determines whether or not to permit performing each of the requests on the basis of the internal address and the internal port number replaced by the conversion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the hardware configuration of a storage device (information processing device) as a redundant system according to an embodiment;

FIG. 2 is a diagram illustrating the outline of the configuration and operation of the storage device (information processing device) according to this embodiment;

FIG. 3 is a block diagram illustrating an example of the functional configuration of a storage control device (CM) illustrated in FIG. 1;

FIG. 4 is a flowchart illustrating the operation of a front-end program according to this embodiment processing reception from an external client;

FIG. 5 is a flowchart illustrating the operation of a configuration change program according to this embodiment;

FIG. 6 is a flowchart illustrating the operation of the front-end program according to this embodiment processing transmission to the external client;

FIGS. 7 and 8 are diagrams illustrating interprocess communication by a loop-back device; and

FIGS. 9 to 15 are diagrams illustrating an intersystem (inter-CM) communication operation in this embodiment.

### DESCRIPTION OF THE PREFERRED EMBODIMENTS

Hereinafter, an embodiment of an information processing device according to the invention will be described in detail with reference to the accompanying drawings. However, the following embodiment is just illustrative and it is not intended to exclude various modifications and technical applications which are not specified in the embodiment. That is, various modifications and changes of this embodiment can be made without departing from the scope and spirit of the invention. It is understood that each drawing does not include only components illustrated therein and can include other functions. Embodiments can be appropriately combined with each other as long as there is no inconsistency in the content of processes.

[1] Hardware Configuration of Storage Device According to this Embodiment

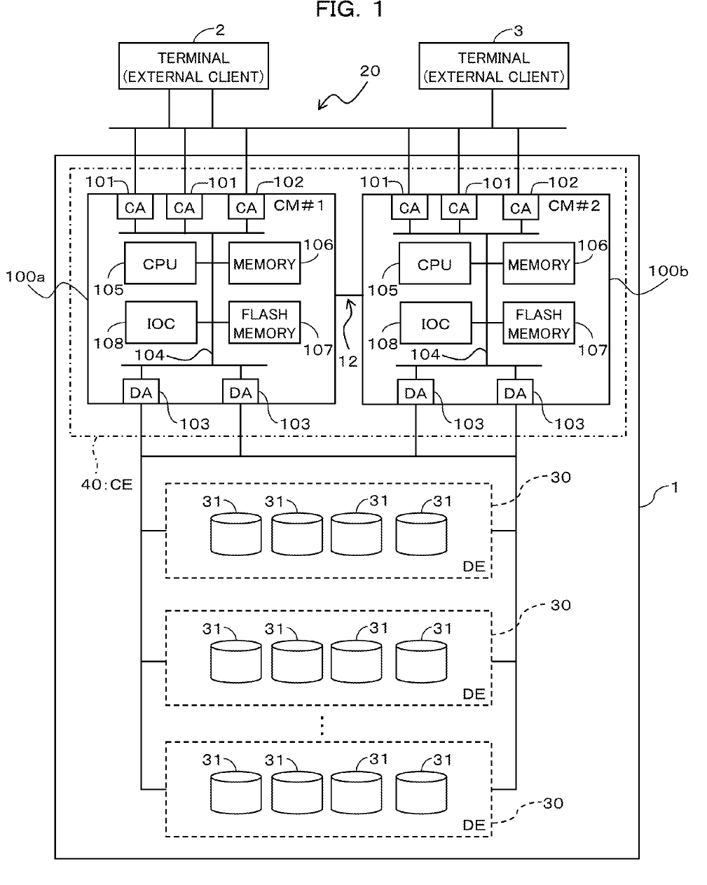

First, an example of the hardware configuration of a storage device (information processing device) 1 as a redundant system according to this embodiment, to which the technique according to the invention is applied, is described with reference to FIG. 1. FIG. 1 is a block diagram illustrating an example of the hardware configuration.

The storage device 1 virtualizes a memory device 31 stored in a drive enclosure (DE) 30 to form a virtual storage environment. Then, the storage device 1 provides a virtual volume to external clients (terminals) 2 and 3.

The storage device 1 is connected to one or more (two in the example illustrated in FIG. 1) external clients 2 and 3 so as to communicate with the external clients 2 and 3. The external clients 2 and 3 and the storage device 1 are connected to each other by communication adapters (CAs) 101 and 102 which are described below.

The external clients 2 and 3 are, for example, information processing terminals having a server function and transmit and receive commands of a network attached storage (NAS) or a storage area network (SAN) to and from the storage device 1. For example, the external clients 2 and 3 transmit a storage access command, such as read/write commands in NAS, to the storage device 1 to write or read data to and from the volume provided by the storage device 1.

Then, the storage device 1 performs a process of reading or writing data from or to the memory device 31 corresponding to the volume, in response to an input/output request (for example, a write request or a read request) for the volume from the external clients 2 and 3. In some cases, the input/output request from the external clients 2 and 3 is referred to as an I/O request.

In the example illustrated in FIG. 1, two external clients 2 and 3 are illustrated. However, the invention is not limited thereto. For example, three or more external clients may be connected to the storage device 1.

The external clients 2 and 3 connected to the storage device 1 may function as management terminals. The management terminal is an information processing device including an input device, such as a keyboard or a mouse, and a display device and is operated to input various kinds of information by a user such as a system administrator. For example, the user inputs information related to various configurations. The input information is transmitted to the storage device 1. In particular, in this embodiment, the user is capable of issuing various requests for system configuration information which is described below, such as a request to refer to the system configuration information and a request to change the system configuration information, from the external clients 2 and 3 using the function of the management terminal.

As illustrated in FIG. 1, the storage device 1 includes a plurality of (two in this embodiment) controller modules (CMs; storage control devices; and processing units or processing modules) 100a and 100b and one or more (three in the example illustrated in FIG. 1) drive enclosures 30.

The drive enclosure 30 is capable of being provided with one or more (four in the example illustrated in FIG. 1) memory devices (physical disks) 31 and provides the storage areas (actual volumes or actual storages) of the memory devices 31 to the storage device 1.

For example, the drive enclosure 30 includes slots (not illustrated) in a plurality of stages. The memory device 31 is inserted into the slot to change an actual volume space at any time. It is possible to configure redundant arrays of inexpensive disks (RAID), using a plurality of memory devices 31.

The memory device 31 is a memory device, such as a hard disk drive (HDD) or a solid state drive (SSD) having a higher capacity than a memory 106, which is described below, and stores various kinds of data. Hereinafter, in some cases, the memory device is referred to as a drive or a disk.

Each drive enclosure 30 is connected to device adapters (DAs) 103 of the CM 100a and the DAs 103 of the CM 100b. Any of the CMs 100a and 100b accesses each drive enclosure 30 to write or read data. That is, each of the CMs 100a and 100b is connected to each memory device 31 of the drive enclosure 30 such that an access path to the memory device 31 is redundant.

That is, a controller enclosure 40 includes two or more (two in the example illustrated in FIG. 1) CMs 100a and 100b in order to form a redundant access path to the memory device 31 as described above.

The CMs 100a and 100b are controllers (storage control devices) that control an operation in the storage device 1 and performs various kinds of control, such as data access control to the memory device 31 of the drive enclosure 30, in response to an IO command transmitted from the external clients 2 and 3. The CMs 100a and 100b have the same configuration. Hereinafter, as a reference numeral indicating CM, reference numerals 100a and 100b are used when one of a plurality of CMs is specified and reference numeral 100 is used when an arbitrary CM is specified. In some cases, the CM 100a is referred to as a master CM, CM #1, or a master system and the CM 100b is referred to as a slave CM, CM #2, or a slave system.

The CMs 100a and 100b are duplexed. In general, the CM 100a (CM #1) functions as a master and performs various kinds of control. However, when the master CM 100a is out of order, the slave CM 100b (CM #2) functions as a primary system and takes over the operation of the CM 100a.

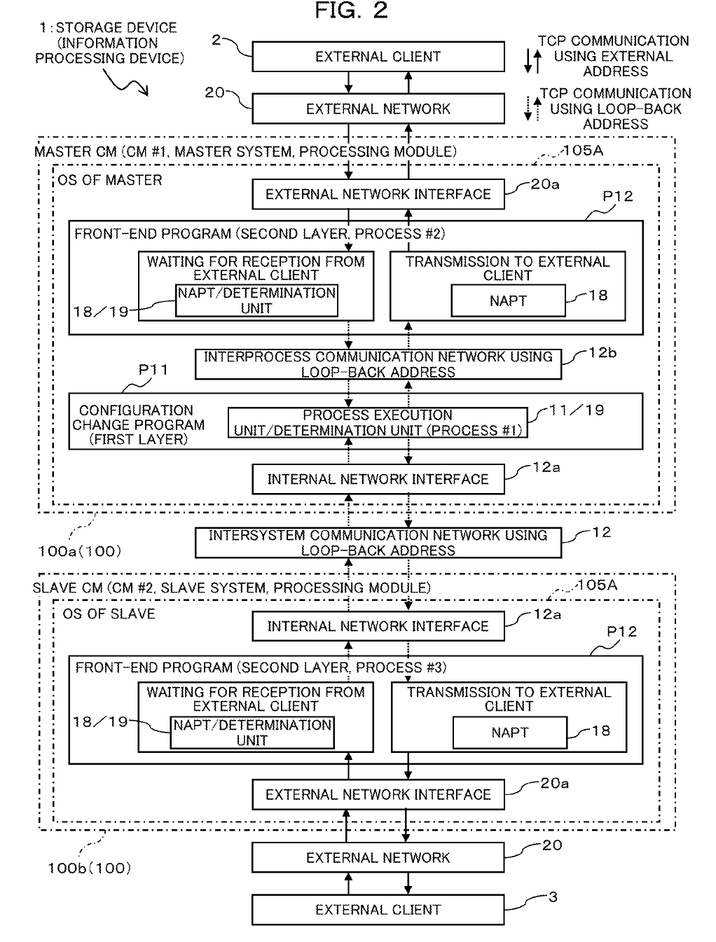

The CMs 100a and 100b are connected to the external clients 2 and 3 through the CAs 101 and 102. The CMs 100a and 100b receive an I/O request, such as a read/write request transmitted from the external clients 2 and 3, and controls the memory device 31 through, for example, the DA 103. In addition, the CMs 100a and 100b are connected through an inter-system (inter-CM) communication network 12 using a loop-back address so as to communicate with each other, as described below with reference to FIG. 2.

As illustrated in FIG. 1, each CM 100 includes the CAs 101 and 102, a plurality of (two in the example illustrated in FIG. 1) DAs 103, a central processing unit (CPU) 105, a memory 106, a flash memory 107, and an input/output controller (IOC) 108. The CAs 101 and 102, the DA 103, the CPU 105, the memory 106, the flash memory 107, and the IOC 108 are connected through, for example, a PCIe interface 104 so as to communicate with each other.

The CAs 101 and 102 receive data transmitted from, for example, the external clients 2 and 3 or transmit data output from the CM 100 to the external clients 2 and 3. That is, the CAs 101 and 102 control the input and output of data from and to external devices such as the external clients 2 and 3.

The CA 101 is a network adapter that is connected to the external clients 2 and 3 through a NAS so as to communicate with the external clients 2 and 3 and is, for example, a local area network (LAN) interface. Each CM 100 is connected to, for example, the external clients 2 and 3 through a communication circuit (not illustrated) by the CA 101 and the NAS and receives an I/O request from the external clients 2 and 3 or transmits and receives data to and from the external clients 2 and 3. In the example illustrated in FIG. 1, each of the CMs 100a and 100b includes two CAs 101.

The CA 102 is a network adapter that is connected to the host device 2 through the SAN so as to communicate with the host device 2 and is, for example, an Internet small computer system interface (iSCSI) interface or a fibre channel (FC) interface. Each CM 100 is connected to, for example, the external clients 2 and 3 through a communication circuit (not illustrated) by the CA 102 and the SAN and receives an I/O request from the external clients 2 and 3 or transmits and receives data to and from the external clients 2 and 3. In the example illustrated in FIG. 1, each of the CMs 100a and 100b includes one CA 102.

The DA 103 is an interface for connecting the CM to, for example, the drive enclosure 30 or the memory device 31 so as to communicate with the drive enclosure 30 or the memory device 31. The DA 103 is connected to the memory devices 31 of the drive enclosure 30.

Each CM 100 performs access control to the memory device 31 through the DA 103 to write or read data to and from the memory device 31 on the basis of the I/O request received from the external clients 2 and 3. In the example illustrated in FIG. 1, each of the CMs 100a and 100b includes two DAs 103. In each of the CMs 100a and 100b, each DA 103 is connected to the drive enclosure 30.

Therefore, each of the CMs 100a and 100b is capable of writing or reading data to and from the memory devices 31 of the drive enclosure 30.

The flash memory 107 is a memory device that stores, for example, programs executed by the CPU 105 and various kinds of data. Examples of the program include a configuration change program P11 and a front-end program P12 illustrated in FIG. 2 and examples of the various kinds of data include system configuration information (which is described below) and information indicating whether there is a “TCP connection that is being processed” (which is described below). These information items may be stored in the memory 106. Each of the memory 106 and the flash memory 107 is an example of a first storage unit or a second storage unit.

The memory 106 is a memory device that temporarily stores various kinds of data or programs. For example, a cache area of the memory 106 temporarily stores data received from the external clients 2 and 3 and data to be transmitted to the external clients 2 and 3. An application memory area of the memory 106 temporarily stores data or programs when the CPU 105 executes an application program. The application program is, for example, the configuration change program P11 or the front-end program P12 (see FIG. 2) which is executed by the CPU 105 in order to implement an exclusive control function according to this embodiment. These programs P11 and P12 are stored in the memory 106 or the flash memory 107. The memory 106 is, for example, a random access memory (RAM) that has a higher access speed than the memory device (drive) 31 and has a lower capacity than the memory device 31.

The IOC 108 is a control device that controls data transmission in each CM 100 and implements, for example, direct memory access (DMA) that transmits data stored in the memory 106 without passing through the CPU 105.

The CPU 105 is a processing device that performs various kinds of control or operations and is, for example, a multi-core processor (multi CPU). The CPU 105 executes an operating system (OS) or a program stored in, for example, the memory 106 or the flash memory 107 to implement various functions.

[2] Outline of Configuration and Operation of Storage Device According to this Embodiment

Next, the outlines (1) to (5) of the configuration and operation of the storage device (information processing device) 1 according to this embodiment are described with reference to FIG. 2. FIG. 2 is a diagram illustrating the outline of the configuration and operation.

In this embodiment, for example, in the redundant storage device 1 using a TCP interface for the communication between a host system and another system, it is assumed that a system that stores configuration information for defining, for example, a device configuration or a system configuration and manages the configuration information is referred to as a master system and the other system is a slave system. That is, the master CM 100a manages the configuration information in an integrated fashion. In this case, the host system is the master CM 100a and the other system is the slave CM 100b. In addition, the communication between the systems is referred to as an intersystem communication or an inter-CM communication.

In the storage device 1 illustrated in FIG. 2, the external client 2 is connected to the master CM 100a through an external network 20 so as to communicate with the master CM 100a and the external client 3 is connected to the slave CM 100b through the external network 20 so as to communicate with the slave CM 100b.

Each CM 100 of the storage device 1 is capable of being connected to the external network 20. The storage device 1 includes an external network interface 20a, an internal network interface 12a, the intersystem communication network 12, and an interprocess communication network 12b which are described below, in addition to two CMs 100.

The external network interface 20a is provided in each CM 100 and is connected to the external network 20.

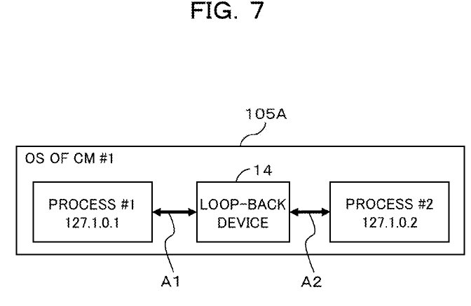

The internal network interface 12a is provided in each CM 100 and is connected to the intersystem communication network (internal network) 12 that connects the CMs 100a and 100b so as to communicate with each other. The intersystem communication network 12 is constructed by a second address system that is different from a first address system of the external network 20 connected to the external network interface 20a, as described below with reference to FIGS. 7 to 15. The internal network interface 12a of each CM 100 performs communication between the CMs 100a and 100b through the intersystem communication network 12 using the second address system (a loop-back address which is described below).

The interprocess communication network 12b is provided only in the master CM 100a in the storage device 1 illustrated in FIG. 2. However, the interprocess communication network 12b may also be provided in the slave CM 100b. The interprocess communication network 12b is used when two processes (applications) on the same OS 105A are associated with each other by a loop-back device 14, as described below with reference to FIG. 7. In the storage device 1 illustrated in FIG. 2, the interprocess communication network 12b is used when communication between process #1 executed by the configuration change program (first layer) P11 and process #2 executed by the front-end program (second layer) P12 is performed. Process #1 corresponds to a process for implementing the functions of a process execution unit (reference/change unit) 11 and a determination unit 19 which are described below. Processes #2 and #3 correspond to a process for implementing the functions of a network address port translation (NAPT) mechanism 18 and a determination unit 19 which are described below.

In the master CM 100a illustrated in FIG. 2, the external network interface 20a, the internal network interface 12a, and the interprocess communication network 12b operate on the OS 105A that operates on the CPU 105. The configuration change program P11 (process #1) is executed on the OS 105A to implement the functions of the process execution unit 11 and the determination unit 19 which are described below. The front-end program P12 (process #2) is executed on the OS 105A to implement the functions of the NAPT mechanism 18 and the determination unit 19 which are described below.

In the slave CM 100b illustrated in FIG. 2, the external network interface 20a and the internal network interface 12a operate on the OS 105A that operates on the CPU 105. The front-end program P12 (process #3) is executed on the OS 105A to implement the functions of the NAPT mechanism 18 and the determination unit 19 which are described below. In practice, the configuration is considered in which it is possible to dynamically change whether each CM 100 functions as a master or a slave during operation and each CM 100 is provided with both the configuration change program P11 and the front-end program P12.

Here, the external network 20 is Ethernet (registered trademark) that is managed by the user of the storage device 1. The internal network 12 of the storage device 1 is a frame relay communication circuit that connects two CMs 100a and 100b in the storage device 1. The CMs 100a and 100b cooperate with each other through the internal network 12.

Next, the outlines (1) to (5) of the configuration and operation of the storage device 1 according to this embodiment are described with reference to FIG. 2.

(1) In the storage device 1 illustrated in FIG. 2, a function of managing the configuration information for defining, for example, a device configuration or a system configuration has a two-layer structure. A first layer corresponds to the configuration change program P11 that performs, for example, a process of referring to/changing the configuration information. In process #1, the first layer implements the functions of the process execution unit 11 and the determination unit 19 which are described below. A second layer corresponds to the front-end program P12 that waits for the reception of a TCP connection request from the external clients 2 and 3 (waits for reception from the external clients 2 and 3) and performs transmission to the external clients 2 and 3. When the TCP connection request is received, the second layer replaces the address and port number of the request to an internal address and an internal port number for a received packet. Then, the second layer transmits the request (received packet) with the replaced internal address and internal port number to the configuration change program P11 (process #1) through the intersystem communication network 12 or the interprocess communication network 12b. The replacement with the internal address and the internal port number is performed by the NAPT mechanism 18.

(2) As described above, in this embodiment, the configuration change program P11 is provided only in the master CM 100a and implements the functions of the process execution unit 11 and the determination unit 19 which are described below. The configuration change program P11 (process #1) waits for the TCP connection request which has been transmitted from the external clients 2 and 3 and of which the address and port number have been replaced with the internal address and the internal port number by the front-end program P12 (process #2 or #3). The configuration change program P11 prevents two or more TCP connection requests from being received at the same time. In other words, the configuration change program P11 operates so as to receive only one TCP connection request at the same time. That is, when there is a TCP connection that is being processed by the process execution unit 11, the configuration change program P11 does not receive a new TCP connection. Therefore, it is possible to omit complicated exclusive control. That is, it is possible to simply perform exclusive control for a request for the configuration information of the redundant system 1.

(3) The front-end program P12 has a NAPT mechanism 18. The NAPT mechanism 18 is provided in each CM 100. The NAPT mechanism 18 replaces the address and port number of the TCP connection request from the external clients 2 and 3 with an internal address and an internal port number and transmits the request (received packet) to the configuration change program P11 through the intersystem communication network 12 or the interprocess communication network 12b. Here, the address and port number of the TCP connection request from the external clients 2 and 3 are based on the first address system and the internal address and the internal port number are based on the second address system (loop-back address system). The general NAPT mechanism 18 is not capable of converting the external address into a loop-back address. However, the NAPT mechanism 18 according to this embodiment is capable of converting, for example, the external address into an address in the loop-back address range. The conversion by the NAPT mechanism 18 is performed only for connections corresponding to one TCP connection request at the same time. As such, the front-end program P12 according to this embodiment is configured such that, when there is a TCP connection that is being processed by the process execution unit 11, it does not transmit another TCP connection request to the configuration change program P11 of the first layer. Therefore, when there is a TCP connection that is being processed by the process execution unit 11, the front-end program P12 does not receive a new TCP connection. As a result, it is possible to omit complicated exclusive control. That is, it is possible to simply perform exclusive control for a request for the configuration information of the redundant system 1. In addition, it is possible to prevent, for example, the deterioration of the performance due to the concentration of many TCP connection requests on the master CM 100a.

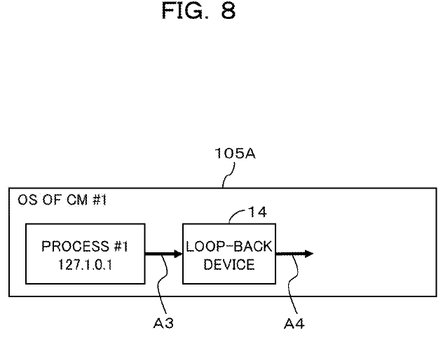

(4) A loop-back address is used as the second address system used for intersystem communication. The loop-back address is originally used in one OS 105A, as described below with reference to FIGS. 7 and 8. In this embodiment, a loop-back address within a certain range is allocated to the intersystem communication network 12 such that the CMs 100a and 100b are capable of communicating with each other. Therefore, a collision avoidance process between an address used for the communication between the external clients 2 and 3 and the CM 100 and an address for the communication between the CMs 100a and 100b is not demanded.

(5) When a TCP connection request is not received as described in the items (2) and (3), each layer (the determination unit 19 which is described below) returns a reset signal (TCP_RST) to the external clients 2 and 3 which have issued the TCP connection request. Therefore, the external clients 2 and 3 are capable of distinguishing a case in which there is no response due to the shutdown of the system from exclusive control for the TCP connection request.

Here, the behavior of the clients 2 and 3, when TCP multiple connections occur or when system 1 is shut down, is described in detail. In the configuration change program P11 of the first layer, the number of listen queues is set to 0. Therefore, when multiple connections are detected in the first layer, a reset response is transmitted to the clients 2 and 3. When TCP multiple connections are detected in the front-end program P12 of the second layer, a reset response is performed in the program P12. Therefore, a reset response is transmitted to the clients 2 and 3. Since the reset response is performed in any case, it is possible to immediately disconnect the client 2 or 3. In contrast, when system 1 is shut down, no response is returned. Therefore, the connection of the clients 2 and 3 is timed out. As such, the clients 2 and 3 are capable of determining whether multiple connections are detected or whether the system is shut down.

As such, according to the storage device 1 of this embodiment, as in the related art, complicated exclusive control for a TCP connection request is not demanded and it is possible to implement a function of referring to/changing system configuration information with minimum communication (costs).

Next, the intersystem (CM) communication network 12 and the interprocess (interapplication) communication network 12b according to this embodiment is described in detail.

In the storage device 1 according to this embodiment, the second address system different from the first address system (192.168.1.0/24) of the external network 20 is constructed in the intersystem (CM) communication network 12 as the internal network. Therefore, in this embodiment, the address system of the interprocess (interapplication) communication performed by the loop-back device 14 is used as the second address system.

A packet that flows through the loop-back device 14 is not output to the outside of the OS 105A using the packet in terms of the characteristics of the loop-back device 14. As illustrated in FIG. 7, for example, the packet is used for cooperation between two processes #1 and #2 in one OS 105A (see arrows A1 and A2 in FIG. 7). FIG. 7 illustrates an example in which interprocess communication is performed on the master CM 100a and an address 127.1.0.1 and an address 127.1.0.2 are allocated to processes #1 and #2, respectively. In the interprocess communication network 12b illustrated in FIG. 2, communication is performed by the method illustrated in FIG. 7. As illustrated in FIG. 8, a packet addressed to the loop-back device 14 is capable of being transmitted even when there is no transmission destination (see arrows A3 and A4 in FIG. 8). That is, even when there is no transmission destination, it is possible to transmit a packet without any error. However, a packet without a transmission destination is transmitted to the loop-back device 14 and is then discarded. FIGS. 7 and 8 are diagrams illustrating interprocess communication performed by the loop-back device 14.

The address system of the interprocess communication performed by the loop-back device 14 is 127.0.0.0/8 and it is possible to ensure about 16.77 million host addresses. Therefore, in this embodiment, in the CMs 100a and 100b forming the storage device 1, the Internet protocol (IP) addresses on the loop-back device 14 are allocated so as not to collide with each other.

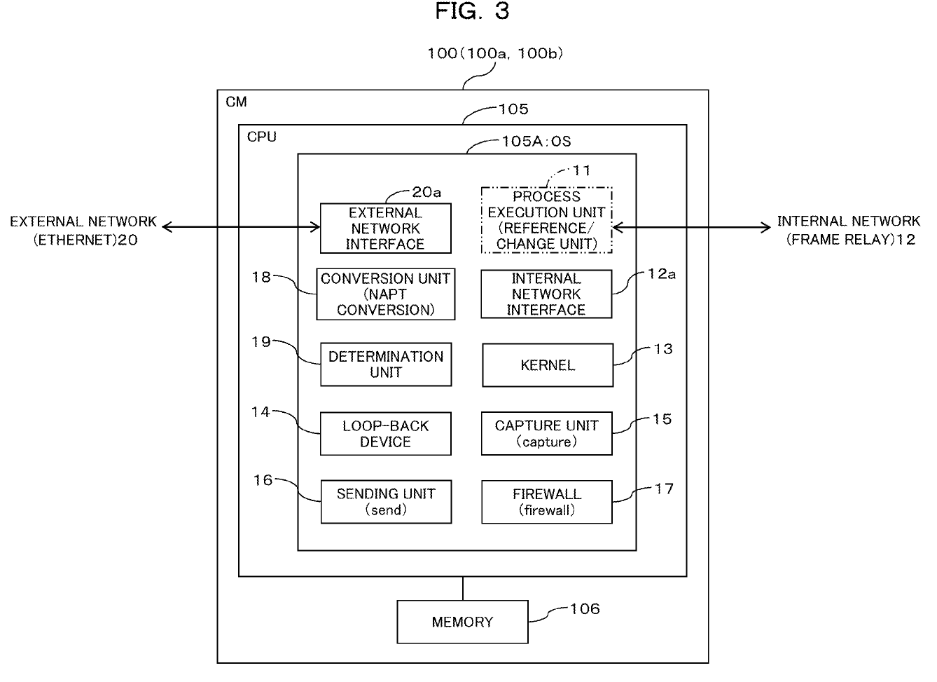

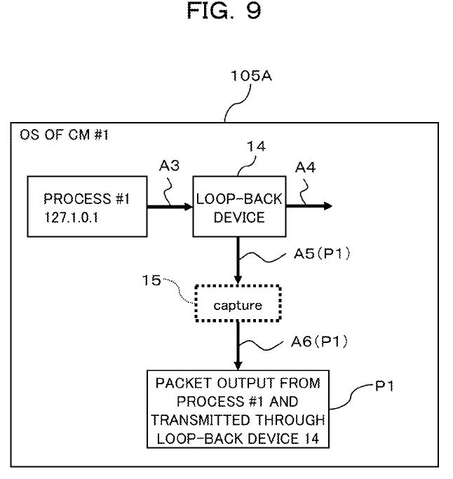

The internal network interface 12a performs the communication between the CMs 100a and 100b, using the address system of the interprocess communication performed by the loop-back device 14 which is the second address system different from the first address system of the external network 20. However, as described above, a packet that flows through the loop-back device 14 is not output to the outside of the OS 105A using the packet in terms of the characteristics of the loop-back device 14. Therefore, in this embodiment, the functional configuration of each CPU 105, which is described below with reference to FIG. 3, is used to construct an IP network using the loop-back device 14, as described below with reference to FIGS. 9 to 15.

For example, not IP communication but a general-purpose communication circuit is used as the internal network 12 that connects the CMs 100 such that the CMs 100 are capable of communicating with each other. It is possible to use, for example, a frame relay communication circuit (for example, a serial circuit or Ethernet without using IP) as the general-purpose communication circuit. In the example illustrated in FIG. 1, the frame relay communication circuit is used as the internal network 12. With this configuration, the internal network interface 12a of each CM 100 has the functions of a frame relay transmission unit and a frame relay receiving unit. For example, a relay is used in the CM 100 to construct a network environment in which frame relay communication is capable of being performed between arbitrary CMs 100.

Instead of using the general-purpose communication circuit, a shared memory (not illustrated) between a plurality of CMs 100 may be provided as the internal network 12 and the communication between the CMs 100 may be performed through the shared memory.

[3] Functional Configuration of Storage Control Device (CM) According to this Embodiment

Next, the functional configuration of the storage control device (CM) 100 according to this embodiment is described with reference to FIG. 3. FIG. 3 is a block diagram illustrating an example of the functional configuration of the CM 100 (processing unit or processing module) illustrated in FIG. 1.

In the CM 100 according to this embodiment, the CPU 105 executes the configuration change program P11 and the front-end program P12 to function as the process execution unit 11, the NAPT mechanism 18, and the determination unit 19. The process execution unit 11 operates only in the master CM 100a and does not operate in the slave CM 100b. In addition, the CPU 105 executes an application program (not illustrated) to function as the external network interface 20a, the internal network interface 12a, a capture unit 15, a sending unit 16, and a firewall 17.

The configuration change program P11, the front-end program P12, or the application program (not illustrated) is recorded in a portable non-transitory recording medium, which is a computer-readable recording medium, and is then provided. Examples of the recording medium include a magnetic disk, an optical disc, and a magneto-optical disc. Examples of the optical disc include a compact disk (CD), a digital versatile disk (DVD), and a Blu-ray disc. Examples of the CD include a read only memory (CD-ROM) and a CD-R (Recordable)/RW (Rewritable). Examples of the DVD include a DVD-RAM, a DVD-ROM, a DVD-R, a DVD+R, a DVD-RW, a DVD+RW, and a high definition (HD) DVD.

In this case, the CPU 105 reads, for example, various programs P11 and P12 from the recording medium, stores the programs in an internal memory device (for example, the memory 106 or the flash memory 107) or an external memory device, and uses the programs. In addition, the CPU 105 may receive, for example, various programs P11 and P12 through a network, store the programs in the internal memory device or the external memory device, and use the programs.

The process execution unit (reference/change unit) 11 operates in the master CM 100a. When a request related to the system configuration information for defining, for example, the configuration of the storage device (redundant system) 1 is received from the external clients 2 and 3, the process execution unit 11 performs various processes, such as a reference processing and a change processing, for the configuration information in response to the request.

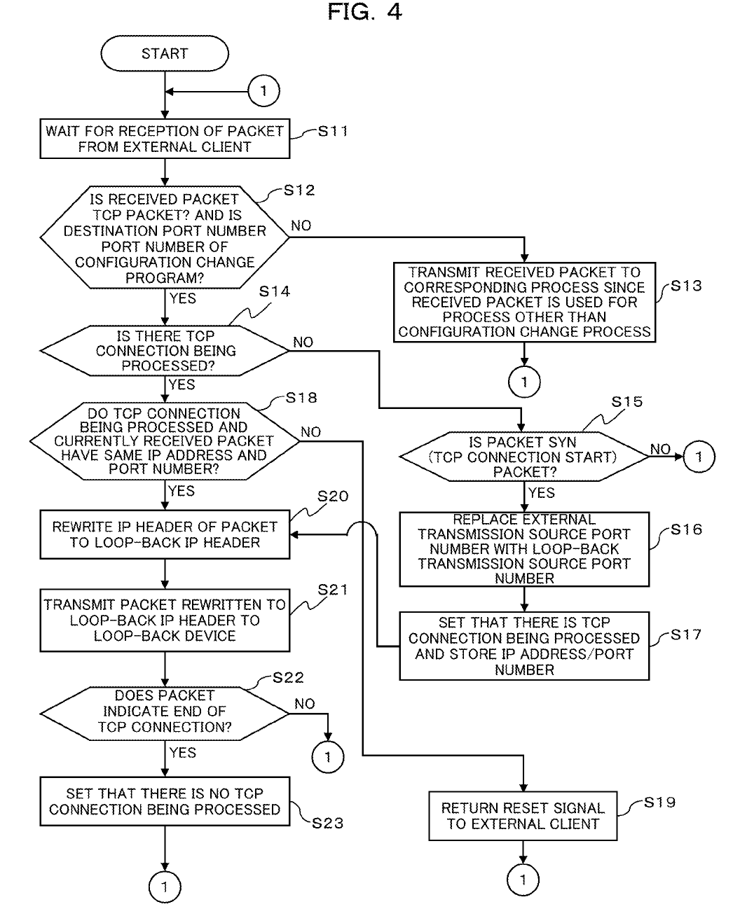

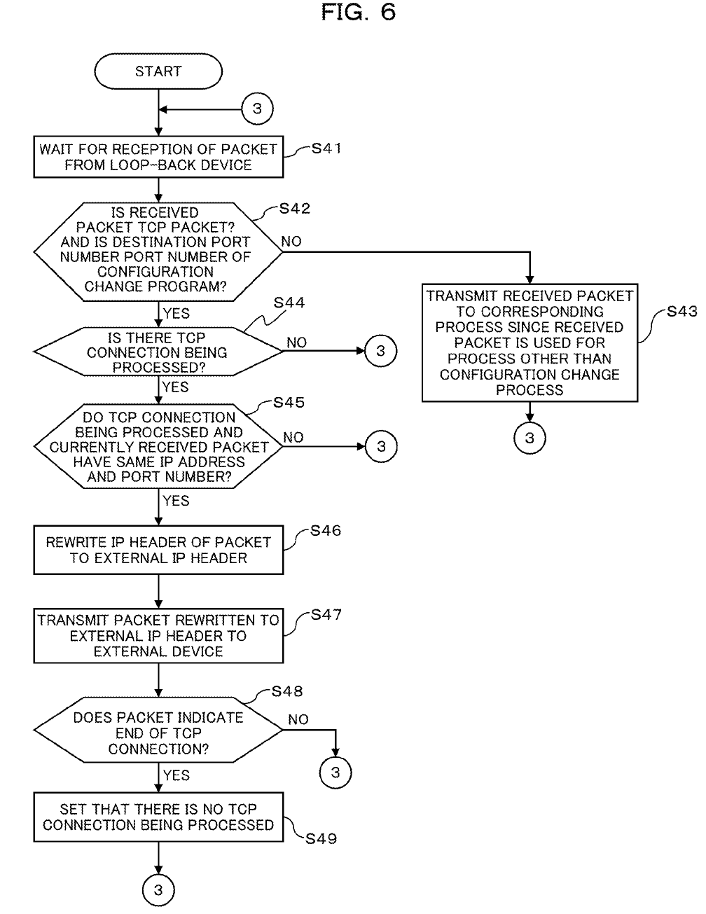

The conversion unit (NAPT mechanism) 18 operates in each CM 100. When a request (TCP access), such as a reference/change request for the system configuration information, is received from the external clients 2 and 3, the conversion unit 18 replaces the address and port number (first address system) of the request with an internal address and an internal port number (second address system). The conversion unit 18 is used in Steps S16 and S20 of FIG. 4 and Step S46 of FIG. 6. The internal address and the internal port number replaced by the conversion unit 18 are overwritten and stored in the memory 106 (or the flash memory 107). In this case, when the request is received from the same request source in the external clients 2 and 3, the conversion unit 18 replaces the address and port number of the request with the same internal address and internal port number. In addition, when the request is received from different request sources in the external clients 2 and 3, the conversion unit 18 replaces the address and port number of the request with different internal addresses and internal port numbers of the request sources.

The determination unit 19 operates in each CM 100 and determines whether or not to permit performing the request by the process execution unit 11 on the basis of the internal address and the internal port number replaced by the NAPT mechanism 18. In this way, the determination unit 19 prevents two or more requests from being performed at the same time.

The determination unit 19 may be provided only in the master CM 100a or may be provided in each CM 100. In this embodiment, the determination unit 19 is provided in each of two CMs 100a and 100b.

When a request is received from the external clients 2 and 3, the determination unit 19 refers to the memory 106. When an internal address and an internal port number have not been stored in the memory 106, the determination unit 19 stores the internal address and the internal port number replaced by the conversion unit 18 in the memory 106 and determines to permit performing the request.

In contrast, when an internal address and an internal port number have been stored in the memory 106, the determination unit 19 compares the internal address and the internal port number stored in the storage unit 106 with the internal address and the internal port number replaced by the conversion unit 18 for the currently received request.

When the comparison result shows that the internal addresses and the internal port numbers are identical to each other, the determination unit 19 determines to permit performing the request. On the other hand, when the comparison result shows that the internal addresses and the internal port numbers are not identical to each other, the determination unit 19 determines not to permit performing the request and returns a reset signal to the external clients 2 and 3.

The detailed functions of the determination unit 19 is described below with reference to FIGS. 4 to 6.

In each CM 100, the external network interface 20a is connected to the external network 20 by the first address system (192.168.1.0/24) of the external network (Ethernet) 20 and communicates with the external clients 2 and 3.

As described above, in each CM 100, the internal network interface 12a performs the communication between the CMs 100 using the address system (127.1.0.1/5) of the interprocess communication by the loop-back device 14.

The internal network interface 12a has a function of selecting a packet addressed to the host CM and transmitting the packet to the sending unit 16 (which is described below) and a function of transmitting packets other than the packet addressed to the host CM (host processing module) to another CM (another processing module).

The capture unit 15 acquires a packet P1 (see FIGS. 9 to 13) that has been generated by a transmission source process (see process #1 in, for example, FIGS. 9 to 13) and transmitted through the loop-back device 14 in the OS 105A. It is possible to implement the function of the capture unit 15, using a capture function that is originally provided in the OS 105A. The capture function captures a packet in order to monitor the state of the network. The capture unit 15 captures the packet P1 transmitted through the loop-back device 14, using the capture function. The internal network interface 12a outputs the packet P1 captured by the capture unit 15 to the internal network 12 and transmits the packet P1 to a transmission destination CM (transmission destination processing module) according to the address system of the interprocess communication by the loop-back device 14.

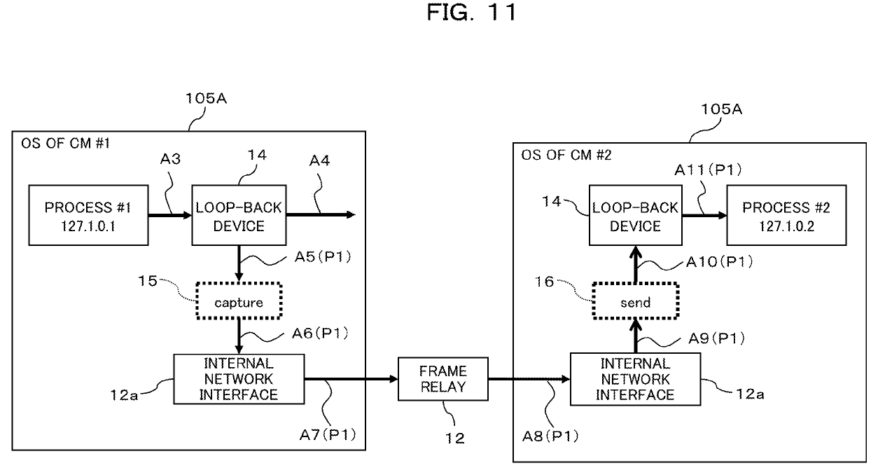

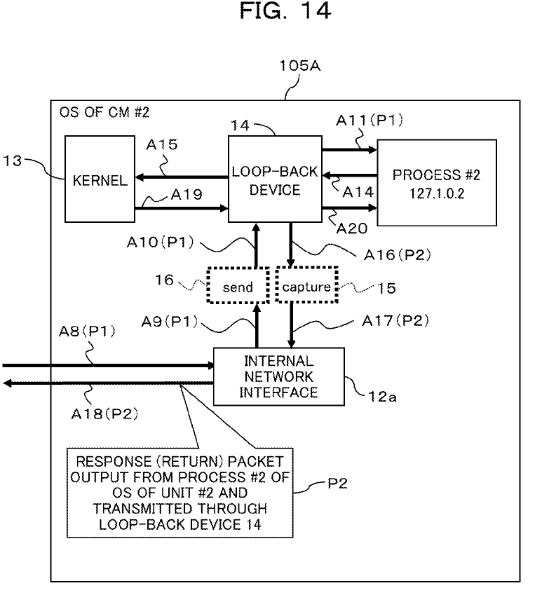

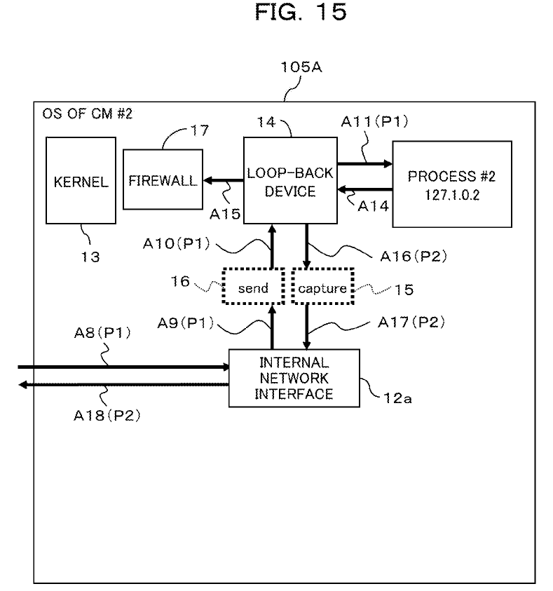

In addition, the capture unit 15 captures a response packet P2 (see FIGS. 14 and 15) to the transmission source process (see process #1) of another CM 100 which has been generated by a transmission destination process (see process #2 in FIGS. 11, 14, and 15) and transmitted through the loop-back device 14. The capture unit 15 captures the response packet P2 transmitted through the loop-back device 14, using the capture function. The internal network interface 12a outputs the response packet P2 captured by the capture unit 15 to the internal network 12 and transmits the packet P2 to a transmission source process of another CM 100 according to the address system of the interprocess communication by the loop-back device 14.

The sending unit 16 starts when the internal network interface 12a receives the packet transmitted from another CM to the host CM according to the address system of the interprocess communication by the loop-back device 14. When the sending unit 16 starts, the sending unit 16 sends the packet (P1 or P2) addressed to the host CM, which has been received by the internal network interface 12a, to the transmission destination process (process #2 or #1) through the loop-back device 14. It is possible to implement the function of the sending unit 16, using a sending function that is originally provided in the OS 105A.

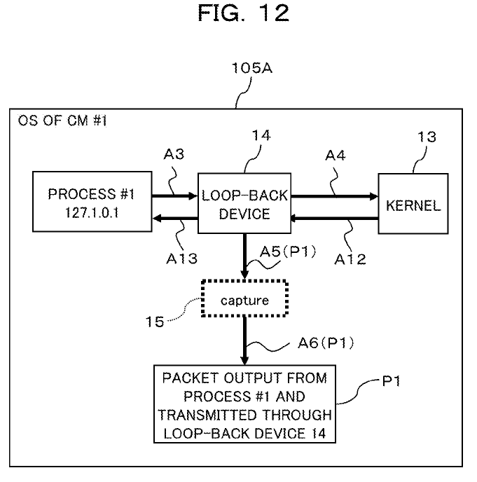

The firewall 17 blocks the packet P1 transmitted through the loop-back device 14 between the loop-back device 14 and a kernel 13 of the OS 105A. In addition, the firewall 17 blocks the response packet P2 transmitted through the loop-back device 14 between the loop-back device 14 and the kernel 13 of the OS 105A. The blocking function of the firewall 17 is described below with reference to FIGS. 12 to 15. The kernel 13 is software that provides the basic functions of an OS, such as a function of monitoring application software or peripheral devices, a function of managing resources, such as a disk and a memory, an interrupt process, and interprocess communication.

The conversion unit (NAPT mechanism) 18 performs address conversion between the first address system of the external network 20 and the second address system of the internal network 12, in the CM 100 connected to the external network 20. The conversion unit 18 enables each CM 100 in the storage device 1 to communicate with the external devices (for example, the external clients 2 and 3) connected to the external network 20.

[4] Operation of Storage Control Device (CM) According to this Embodiment

[4-1] Reception Processing Operation of Front-End Program According to this Embodiment

Next, the operation of the front-end program P12 according to this embodiment processing reception from the external clients 2 and 3 is described with reference to the flowchart (Steps S11 to S23) illustrated in FIG. 4.

As illustrated in FIG. 4, the front-end program P12 (determination unit 19) waits for the reception of a packet from the external clients 2 and 3 (Step S11). When a packet is received from the external clients 2 and 3, the determination unit 19 determines whether the received packet is a TCP packet and the destination port number is the port number of the configuration change program P11 (Step S12).

When the destination port number is not the port number of the configuration change program P11 (a NO route in Step S12), the front-end program P12 determines that the received packet is for processes other than a configuration change process. Therefore, the front-end program P12 transmits the received packet to a process corresponding to the packet (Step S13) and returns to Step S11.

When the destination port number is the port number of the configuration change program P11 (a YES route in Step S12), the determination unit 19 determines whether there is a TCP connection that is being processed, with reference to the memory 106 (or the flash memory 107) (Step S14). That is, the determination unit 19 determines whether information indicating whether there is a “TCP connection that is being processed”, which is set in the memory 106 (or the flash memory 107), indicates “presence” or “absence”. When there is no TCP connection that is being processed (a NO route in Step S14), the determination unit 19 determines whether the received packet is SYN (TCP connection start instruction) (Step S15).

When the received packet is not SYN (TCP connection start instruction) (a NO route in Step S15), the front-end program P12 returns to Step S11.

When the received packet is SYN (TCP connection start instruction) (a YES route in Step S15), the front-end program P12 (NAPT mechanism 18) replaces an external transmission source port number with a loop-back transmission source port number for the received packet (Step S16). Here, the external transmission source port number corresponds to the address and port number of a transmission source based on the first address system and the loop-back transmission source port number corresponds to an internal address and an internal port number based on the second address system.

Then, the front-end program P12 sets the information indicating whether there is a “TCP connection that is being processed” to “presence” in the memory 106 (or the flash memory 107). In addition, the front-end program P12 overwrites and stores the internal address and the internal port number replaced in Step S16 in the memory 106 (or the flash memory 107) (Step S17). Then, the front-end program P12 proceeds to Step S20 which is described below.

On the other hand, when there is a TCP connection that is being processed (a YES route in Step S14), the determination unit 19 determines whether the TCP connection that is being processed and the currently received packet have the same IP address/port number (Step S18). That is, the determination unit 19 compares the internal address and the internal port number stored in the memory 106 with the internal address and the internal port number replaced by the NAPT mechanism 18 for the currently received packet (request).

When the IP addresses/port numbers are not identical to each other, that is, when the comparison result shows that the TCP connection and the received packet do not have the same IP address/port number (a NO route in Step S18), the determination unit 19 determines not to permit performing the request. Then, the determination unit 19 returns a reset signal (TCP_RST) to the external client 2 or 3 which is the transmission sources of the packet, without transmitting the received packet to the first layer (configuration change program P11) (Step S19). Then, the front-end program P12 returns to Step S11.

When the IP addresses/port numbers are identical to each other, that is, when the comparison result shows that the TCP connection and the received packet have the same IP address/port number (a YES route in Step S18), the determination unit 19 permits performing the request. Then, the NAPT mechanism 18 rewrites an IP header of the received packet to a loop-back IP header (Step S20). Here, the IP header of the received packet corresponds to the address and port number of the transmission source based on the first address system and the loop-back IP header corresponds to the internal address and the internal port number based on the second address system.

The loop-back address given in Step S20 is an address that is capable of sending a packet from the second layer (front-end program P12) to the first layer (configuration change program P11). When the front-end program P12 is present in the slave CM 100b, a loop-back address for transmitting a packet from the slave CM 100b (process #3) to the master CM 100a (process #1) through the inter-CM communication network 12 is selected. In contrast, when the front-end program P12 is present in the master CM 100a, a loop-back address that is capable of transmitting a packet from the front-end program P12 (process #2) to the configuration change program P11 (process #1) through the interprocess communication network 12b is selected.

Then, the front-end program P12 sends the packet with the rewritten loop-back IP header to the loop-back device 14 and transmits the packet to the configuration change program P11 through the inter-CM communication network 12 or the interprocess communication network 12b (Step S21).

Then, the front-end program P12 determines whether the packet indicates the end of the TCP connection (Step S22). When the packet does not indicate the end of the TCP connection (a NO route in Step S22), the front-end program P12 returns to Step S11. When the packet indicates the end of the TCP connection (a YES route in Step S22), the front-end program P12 sets the information indicating whether there is a “TCP connection that is being processed” to “absence” in the memory 106 (or the flash memory 107) (Step S23). Then, the front-end program P12 returns to Step S11.

[4-2] Operation of Configuration Change Program According to this Embodiment

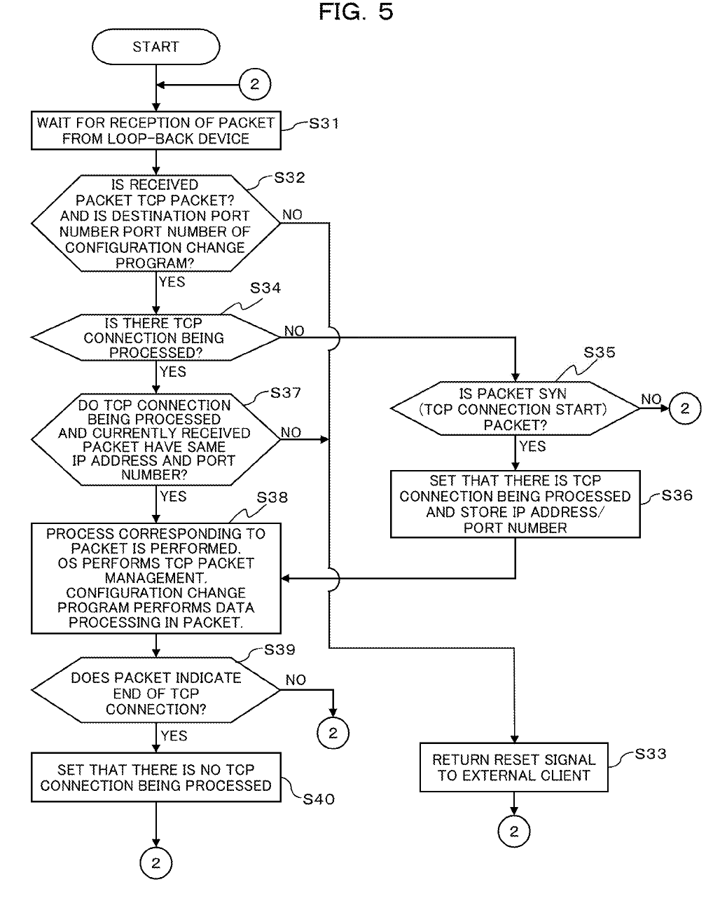

Next, the operation of the configuration change program P11 according to this embodiment is described with reference to the flowchart (Steps S31 to S40) illustrated in FIG. 5.

As illustrated in FIG. 5, the configuration change program P11 (process execution unit 11) waits for the reception of the packet subjected to the receiving process illustrated in FIG. 4 from the loop-back device 14 (the inter-CM communication network 12 or the interprocess communication network 12b) (Step S31). When the packet is received from the loop-back device 14, the configuration change program P11 (determination unit 19) determines whether the received packet is a TCP packet and the destination port number is the port number of the configuration change program P11 (Step S32).

When the destination port number is not the port number of the configuration change program P11 (a NO route in Step S32), the configuration change program P11 returns a reset signal (TCP_RST) to the external client 2 or 3 which is the transmission source of the packet (Step S33). Then, the configuration change program P11 returns to Step S31.

When the destination port number is the port number of the configuration change program P11 (a YES route in Step S32), the determination unit 19 determines whether there is a TCP connection that is being processed, with reference to the memory 106 (or the flash memory 107) (Step S34). That is, the determination unit 19 determines whether information indicating whether there is a “TCP connection that is being processed”, which is set in the memory 106 (or the flash memory 107), indicates “presence” or “absence”. When there is no TCP connection that is being processed (a NO route in Step S34), the determination unit 19 determines whether the received packet is SYN (TCP connection start instruction) (Step S35).

When the received packet is not SYN (TCP connection start instruction) (a NO route in Step S35), the configuration change program P11 returns to Step S31.

When the received packet is SYN (TCP connection start instruction) (a YES route in Step S35), the configuration change program P11 sets the information indicating whether there is a “TCP connection that is being processed” to “presence” in the memory 106 (or the flash memory 107). In addition, the configuration change program P11 overwrites and stores the internal address and the internal port number of the received packet in the memory 106 (or the flash memory 107) (Step S36). Then, the configuration change program P11 proceeds to Step S38 which is described below.

On the other hand, when there is a TCP connection that is being processed (a YES route in Step S34), the determination unit 19 determines whether the TCP connection that is being processed and the currently received packet have the same IP address/port number (Step S37). That is, the determination unit 19 compares the internal address and the internal port number stored in the memory 106 with the internal address and the internal port number replaced by the NAPT mechanism 18 for the currently received packet (request).

When the IP addresses/port numbers are not identical to each other, that is, when the comparison result shows that the TCP connection and the received packet do not have the same IP address/port number (a NO route in Step S37), the determination unit 19 determines not to permit performing the request. Then, the determination unit 19 returns a reset signal (TCP_RST) to the external client 2 or 3 which is the transmission sources of the packet, without performing a process corresponding to the received packet (Step S33). Then, the configuration change program P11 returns to Step S31.

When the IP addresses/port numbers are identical to each other, that is, when the comparison result shows that the TCP connection and the received packet have the same IP address/port number (a YES route in Step S37), the determination unit 19 permits performing the request. Then, the configuration change program P11 (process execution unit 11) performs a process corresponding to the received packet, for example, a reference/change process for the system configuration information. In this case, the management of the TCP packet is performed by the OS 105A. In addition, data in the packet is processed by the configuration change program P11 (process execution unit 11) (Step S38).

Then, the configuration change program P11 determines whether the packet indicates the end of the TCP connection (Step S39). When the packet does not indicate the end of the TCP connection (a NO route in Step S39), the configuration change program P11 returns to Step S31. When the packet indicates the end of the TCP connection (a YES route in Step S39), the configuration change program P11 sets the information indicating whether there is a “TCP connection that is being processed” to “absence” in the memory 106 (or the flash memory 107) (Step S40). Then, the configuration change program P11 returns to Step S31.

[4-3] Transmission Processing Operation of Front-End Program According to this Embodiment

Next, the operation of the front-end program P12 according to this embodiment processing transmission to the external clients 2 and 3 is described with reference to the flowchart (Steps S41 to S49) illustrated in FIG. 6.

As illustrated in FIG. 6, the front-end program P12 (determination unit 19) waits for the reception of a packet from the loop-back device 14 (the inter-CM communication network 12 or the interprocess communication network 12b) (Step S41). When a packet is received from the loop-back device 14, the determination unit 19 determines whether the received packet is a TCP packet and the destination port number is the port number of the configuration change program P11 (Step S42).

When the destination port number is not the port number of the configuration change program P11 (a NO route in Step S42), the front-end program P12 determines that the received packet is for processes other than a configuration change process. Therefore, the front-end program P12 transmits the received packet to a process corresponding to the packet (Step S43) and returns to Step S41.

When the destination port number is the port number of the configuration change program P11 (a YES route in Step S42), the determination unit 19 determines whether there is a TCP connection that is being processed, with reference to the memory 106 (or the flash memory 107) (Step S44). That is, the determination unit 19 determines whether the information indicating whether there is a “TCP connection that is being processed”, which is set in the memory 106 (or the flash memory 107), indicates “presence” or “absence”. When there is no TCP connection that is being processed (a NO route in Step S44), the front-end program P12 returns to Step S41.

On the other hand, when there is a TCP connection that is being processed (a YES route in Step S44), the determination unit 19 determines whether the TCP connection that is being processed and the currently received packet have the same IP address/port number (Step S45). That is, the determination unit 19 compares the internal address and the internal port number stored in the memory 106 with the internal address and the internal port number replaced by the NAPT mechanism 18 for the currently received packet (request).

When the IP addresses/port numbers are not identical to each other, that is, when the comparison result shows that the TCP connection and the received packet do not have the same IP address/port number (a NO route in Step S45), the front-end program P12 returns to Step S41.

When the IP addresses/port numbers are identical to each other, that is, when the comparison result shows that the TCP connection and the received packet have the same IP address/port number (a YES route in Step S45), the NAPT mechanism 18 rewrites an IP header of the received packet to an external IP header (Step S46). Here, the IP header of the received packet corresponds to the internal address and the internal port number based on the second address system and the external IP header corresponds to the address and port number of the transmission source based on the first address system.

Then, the front-end program P12 sends the packet with the rewritten external IP header to an external device (for example, the external network interface 20a) and transmits the packet to the external clients 2 and 3 which are the transmission sources of the packet through the external network 20 (Step S47).

Then, the front-end program P12 determines whether the packet indicates the end of the TCP connection (Step S48). When the packet does not indicate the end of the TCP connection (a NO route in Step S48), the front-end program P12 returns to Step S41. When the packet indicates the end of the TCP connection (a YES route in Step S48), the front-end program P12 sets the information indicating whether there is a “TCP connection that is being processed” to “absence” in the memory 106 (or the flash memory 107) (Step S49). Then, the front-end program P12 returns to Step S41.

[5] Intersystem (Inter-CM) Communication Operation According to this Embodiment

Next, an intersystem (inter-CM) communication operation of the storage device 1 according to this embodiment having the above-mentioned configuration is described in detail with reference to FIGS. 9 to 15. FIGS. 9 to 15 are diagrams illustrating the intersystem (inter-CM) communication operation according to this embodiment. In FIGS. 9 to 15, a communication operation between the master CM 100a (CM #1) and the slave CM 100b (CM #2) is described while only the configuration of a main portion of each CM 100 is illustrated. IP addresses 127.1.0.1 and 127.1.0.2 based on the address system of the interprocess communication by the loop-back device 14 are allocated to process #1 of CM #1 and process #2 of CM #2, respectively. In FIGS. 9 to 15, since the same or substantially same components are denoted by the same reference numerals as described above, the description thereof is not repeated.

First, a basic inter-CM communication process is described with reference to FIGS. 9 to 11.

When communication between CM #1 and CM #2 is performed, process (transmission source process) #1 of transmission source CM #1 generates a packet to be transmitted to process (transmission destination process) #2 of transmission destination CM #2 and outputs the packet to the loop-back device 14 (see arrows A3 and A4 in FIG. 9).

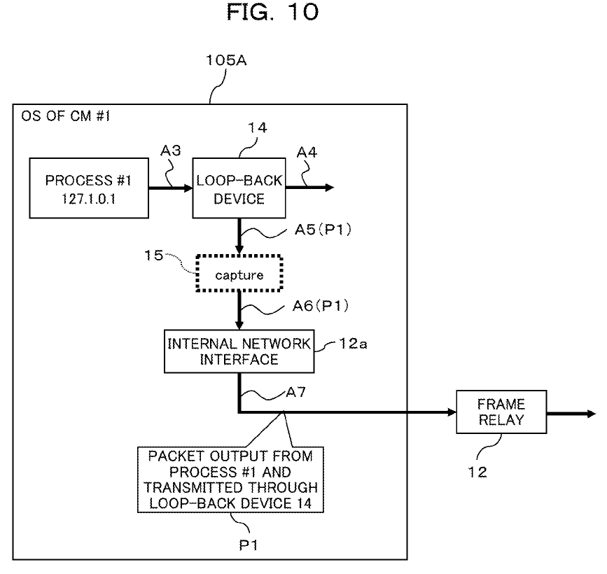

In this case, the capture unit (capture) 15 performs packet capture for the loop-back device 14 to extract the packet P1 addressed to transmission destination process #2 (see arrows A5 and A6 in FIG. 9). Then, the packet P1 extracted by the capture unit 15 is output to an appropriate frame relay 12 corresponding to the IP address of transmission destination process #2 by the internal network interface 12a that functions as a frame relay transmission unit (see an arrow A7 in FIGS. 10 and 11). In this way, the packet P1 is transmitted to transmission destination CM #2.

The packet P1 transmitted by the frame relay 12 is received by the internal network interface 12a functioning as a frame relay receiving unit in transmission destination CM #2 (see arrow A8 in FIG. 11). When receiving the packet P1, the internal network interface 12a determines whether the packet P1 is addressed to host CM #2.

When the received packet P1 is addressed to host CM #2, the internal network interface 12a transmits the packet P1 to the sending unit (send) 16 (see arrow A9 in FIG. 11). Then, the sending unit (send) 16 sends the packet P1 to transmission destination process #2 through the loop-back device 14 (see arrows A10 and A11 in FIG. 11).

When the packet P1 is not addressed to host CM #2, the internal network interface 12a transmits the packet P1 to other CMs 100.

The transmission of a packet from CM #2 (process #2) to CM #1 (process #1) is performed in the same order as described above. In this way, the communication between CM #1 and CM #2 is achieved.

The basic inter-CM communication process in this embodiment has been described above. However, in some cases, when TCP communication is performed, the inter-CM communication is not performed, depending on the type of OS, as illustrated in FIG. 12 or FIG. 14. For example, in FIG. 8, the packet transmitted from process #1 disappears after passing through the loop-back device 14. However, in some cases, the kernel 13 receives the packet transmitted through the loop-back device 14, depending on the type of OS (for example, Linux (registered trademark)) (see arrow A4 in FIG. 12). When receiving the packet, the kernel 13 recognizes that the communication is TCP communication for a service (process #2) in which there is no communication (process #2) by the packet and returns a communication end signal, that is, a TCP reset signal (RST) to transmission source process #1 (see arrows A12 and A13 in FIG. 12). The TCP communication is disconnected and communication related to the packet P1 from transmission source process #1 is stopped by the reset signal. Therefore, even when a response to the packet P1 captured as illustrated in FIGS. 9 to 11 is returned from transmission destination CM #2, it is impossible to respond to the return and inter-CM communication ends without being established.

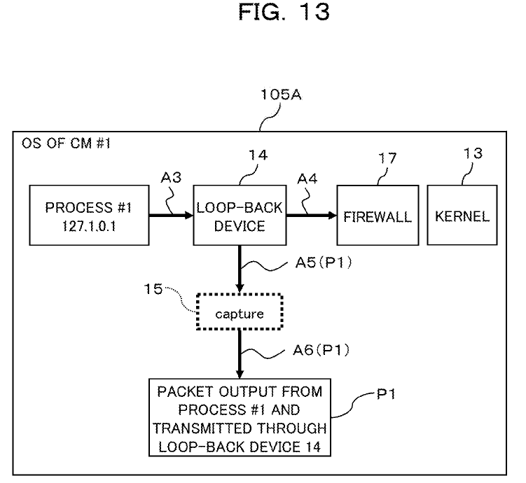

In this embodiment, in order to prevent the occurrence of the above-mentioned situation in transmission source CM #1, the packet P1 addressed to transmission destination CM #2, which has passed through the loop-back device 14, is blocked and discarded by the firewall 17 before reaching the kernel 13 (see an arrow A4 in FIG. 13). Therefore, since the kernel 13 does not receive the packet P1, the reset signal is not returned from the kernel 13 to transmission source process #1 and it is possible to prevent inter-CM communication from ending without being established.

When there is the existing service (process #2) in transmission source CM #1, the service (process #2) in the host OS 105A responds instead of the service (process #2) in another CM #2. That is, when there is no special response, all of the packets to be delivered to addresses in a loop-back address range are received in transmission source CM #1. For example, in FIG. 11, the packet P1 is transmitted to the address 127.1.0.2. However, since the address is in the loop-back address range, the service in the OS 105A of CM #1 receives the packet P1 and responds to the packet P1. This situation is also solved by configuring the firewall 17 as a blocking unit so as to block the packet to be delivered to the address 127.1.0.2.

In FIGS. 12 and 13, transmission source CM #1 has been described. However, as illustrated in FIGS. 14 and 15, in transmission destination CM #2, the problems caused by the reset signal of the kernel 13 are also solved by the function of the firewall 17. That is, as illustrated in FIG. 14, when receiving the packet P1, transmission destination process #2 generates a response packet (return packet) P2 to be transmitted to transmission source process #1 and outputs the response packet P2 to the loop-back device 14 (see arrow A14 in FIG. 14). The response packet P2 transmitted through the loop-back device 14 is captured by the capture unit 15 (see arrows A16 and A17 in FIG. 14). The captured response packet P2 is output to an appropriate frame relay 12 by the internal network interface 12a functioning as a frame relay transmission unit (see arrow A18 in FIG. 14). In this way, the response packet P2 is transmitted to transmission source CM #1.

In this case, in some cases, the response packet P2 transmitted through the loop-back device 14 is received by the kernel 13 (see an arrow A15 in FIG. 14). When receiving the response packet P2, the kernel 13 recognizes that the communication is TCP communication for a service (process #1) in which there is no communication by the packet P2 and returns a TCP reset signal to process #2 (see arrows A19 and A20 in FIG. 14). The TCP communication is disconnected and communication related to the packet P2 from process #2 is stopped by the reset signal. Therefore, even when a response to the response packet P2 is returned from transmission source CM #1, it is impossible to respond to the return and inter-CM communication ends without being established.

In this embodiment, in order to prevent the occurrence of the above-mentioned situation in transmission destination CM #2, the response packet P2 addressed to transmission source CM #1, which has passed through the loop-back device 14, is blocked and discarded by the firewall 17 before reaching the kernel 13 (see an arrow A15 in FIG. 15). Therefore, since the kernel 13 does not receive the response packet P2, the reset signal is not returned from the kernel 13 to process #2 and it is possible to prevent inter-CM communication from ending without being established.

The transmission source port number is automatically given by the OS 105A. An application program is capable of designating the transmission source port number, which is exceptional. Since the loop-back address is present in any OS, the transmission source port number that is automatically allocated by the OS of CM #1 is the same as the port number that is automatically allocated by the OS of CM #2. However, in this embodiment, since the transmission source port number is managed for each IP address, the loop-back address is allocated as an address only for the CM 100 (for example, 127.1.0.2 is used only for the OS of CM #2) to prevent the transmission source port numbers from being the same.

According to this embodiment, in the information processing device 10, it is possible to construct the second address system different from the first address system of the external network 20 in the internal network 12 between the CMs 100 forming the information processing device 10, using the loop-back address. Therefore, it is possible to construct the internal network 12 that is not affected by the external network 20.

Therefore, even when the configuration of the external network 20 is changed, it is unnecessary to change the configuration of the internal network 12. In addition, it is possible to construct the internal network 12 even when the external network 20 has any configuration.

According to this embodiment, even when it is impossible to ensure an address for the internal network 12, it is possible to construct the address system of the internal network 12, using the loop-back address. For example, when all private addresses are suppressed and the device is connected to a global network space, it is impossible to ensure the address for the internal network 12.

Since CM #1 connected to the external network 20 includes the NAPT mechanism 18, each CM 100 in the information processing device 10 is capable of communicating with the external device (for example, the external clients 2 and 3) connected to the external network 20.

In this embodiment, when inter-CM communication is performed using the loop-back address, the packet P1 or the response packet P2 transmitted through the loop-back device 14 is blocked and discarded by the firewall 17 before reaching the kernel 13. Therefore, since the kernel 13 does not receive the packets P1 and P2, the reset signal is not returned from the kernel 13 to the processes which have issued the packets P1 and P2 and it is possible to prevent the inter-CM communication from ending, without being established.

[6] Others

In the above description, the transmission source port number of the external packet is transmitted to the loop-back device 14, without being converted. The reason why this process is possible, that is, a precondition is as follows.

The loop-back address used for the communication (intersystem communication/interprocess communication) between the first layer and the second layer is used only for each system (CM). In addition, an address (an address for internal communication) different from 127.0.0.1 which is generally used as the loop-back address is allocated as the loop-back address.

In the existing system, the address for internal communication is not used. All of the port numbers associated with the address for internal communication are not used. As a result, even when an external transmission source port number is allocated without being converted, no problems arise.

In this embodiment, a plurality of connections are not permitted at the same time. Therefore, in the system, packets with the same transmission source port number are not processed with different IP addresses.

The preferred embodiment of the invention has been described in detail above. The invention is not limited to a specific embodiment and various modifications and changes of the invention can be made without departing from the scope and spirit of the invention.

A computer (including a micro-processing unit (MPU), a CPU, and various terminals) may execute a predetermined program to implement all or some of the functions of the process execution unit 11, the internal network interface 12a, the capture unit 15, the sending unit 16, the firewall 17, the conversion unit 18, the determination unit 19, and the external network interface 20a.

According to this embodiment, it is possible to simply perform exclusive control for a request for the configuration information of a redundant system.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing device comprising:
a plurality of processing modules,
wherein, among the plurality of processing modules, one processing module includes a first storage unit that stores configuration information for defining a configuration of the information processing device,
when one or more requests related to the configuration information in the first storage unit are received from an external terminal, the one processing module performs each of the requests,
when the requests are received from one request source of a plurality of requests sources in the external terminal, each of the plurality of processing modules performs conversion to replace an address and a port number of each of the requests with a same internal address and a same internal port number, and
the information processing device determines whether or not to permit performing each of the requests on the basis of the internal address and the internal port number replaced by the conversion.

2. The information processing device according to claim 1,
wherein the determining is performed by the one processing module.

3. The information processing device according to claim 1,
wherein the determining is performed by each of the plurality of processing modules.

4. The information processing device according to claim 1,
wherein the information processing device further includes a second storage unit that stores the internal address and the internal port number replaced by the conversion,
when each of the requests is received, the information processing device refers to the second storage unit during the determining, and
when the internal address and the internal port number are not stored in the second storage unit, the information processing device stores the internal address and the internal port number replaced by the conversion in the second storage unit and determines to permit performing each of the requests.

5. The information processing device according to claim 4,
wherein, when the internal address and the internal port number are stored in the second storage unit, during the determining, the information processing device compares the internal address and the internal port number stored in the second storage unit with an internal address and an internal port number replaced by the conversion for a currently received request, and
when the comparison results are identical to each other, the information processing device determines to permit performing each of the requests.

6. The information processing device according to claim 5,
wherein, when the comparison results are not identical to each other, during the determining, the information processing device determines not to permit performing each of the requests and returns a reset signal to the external terminal.

7. The information processing device according to claim 1,
wherein each of the plurality of processing modules includes an external network interface that is connected to the external terminal through an external network and an internal network interface that is connected to an internal network constructed by a second address system which is different from a first address system of the external network connected to the external network interface, and
the internal network interface in each of the plurality of processing modules performs communication between the plurality of processing modules using the second address system.

8. The information processing device according to claim 7,
wherein each of the plurality of processing modules includes an operating system and a loop-back device that performs interprocess communication in the operating system, and
an address system of the interprocess communication performed by the loop-back device is used as the second address system.

9. The information processing device according to claim 8,
wherein each of the plurality of processing modules captures a first packet that is generated by a transmission source process and passes through the loop-back device, and
the internal network interface outputs the captured first packet to the internal network such that the captured first packet is transmitted to a transmission destination process according to the second address system.

10. The information processing device according to claim 9,
wherein each of the plurality of processing modules blocks the first packet passing through the loop-back device between the loop-back device and a kernel of the OS.

11. The information processing device according to claim 10,
wherein the internal network interface receives a second packet addressed to the processing module, which includes each of the plurality of processing modules, from another processing module according to the second address system, and
each of the plurality of processing modules sends the second packet, which is received by the internal network interface, to the transmission destination process through the loop-back device.

12. The information processing device according to claim 11,
wherein each of the plurality of processing modules captures a response packet to the transmission source process which is generated by the transmission destination process and transmitted through the loop-back device, and
the internal network interface outputs the captured response packet to the internal network such that the captured response packet is transmitted to the transmission source process according to the second address system.

13. The information processing device according to claim 12,
wherein each of the plurality of processing modules blocks the response packet transmitted through the loop-back device between the loop-back device and the kernel of the OS.

14. The information processing device according to claim 11,
wherein the internal network interface selects the second packet, sends the selected second packet to the transmission destination process through the loop-back device, and transmits packets other than the second packet to other processing modules.
